(19) United States
(12) Patent Application Publication
(10) Pub. No.: US 2015/0143230 A1
(43) Pub. Date: May 21, 2015

(54) METHOD AND DEVICE FOR DISPLAYING WEBPAGE CONTENTS IN BROWSER

(71) Applicant: TENCENT TECHNOLOGY (SHENZHEN) COMPANY LIMITED, Shenzhen (CN)

(72) Inventors: Ning ZHANG, Shenzhen (CN); Zhongshu LIU, Shenzhen (CN); Wenming WANG, Shenzhen (CN); Shuai LIU, Shenzhen (CN); Yishan LI, Shenzhen (CN)

(21) Appl. No.: 14/608,779

(22) Filed: Jan. 29, 2015

Related U.S. Application Data
(63) Continuation of application No. PCT/CN2013/080470, filed on Jul. 31, 2013.

(30) Foreign Application Priority Data
Aug. 3, 2012 (CN) 201210274520.2

(51) Int. Cl. G06F 17/30; G06F 17/22

(52) U.S. Cl. CPC G06F 17/30896; G06F 17/2247
USPC 715/234

(57) ABSTRACT

Examples of the present disclosure provide a method and device for displaying webpage contents in a browser. The method includes: obtaining a webpage requested to be read by a user; determining whether the webpage is a content-based webpage; when determining the webpage is the content-based webpage, extracting a title and text from the webpage based on a default rule, and outputting the title and text in the browser with a default reading mode. By employing the technical solution of the present disclosure, useless information except for the text in a webpage may be filtered.

### CROSS REFERENCE TO RELATED APPLICATION

The application is a continuation of International Patent Application No. PCT/CN2013/080470 filed on 31 Jul. 2013 which claims priority to Chinese Patent Application No. 201210274520.2, titled “method and device for displaying webpage contents in browser”, which was filed on 3 Aug. 2012, the contents of both of said applications are herein incorporated by reference in their entirety.

### TECHNICAL FIELD

The present disclosure relates to network technologies, and more particularly, to a method and device for displaying webpage contents in a browser.

### BACKGROUND

A large number of content-based webpages (e.g., a webpage which provides contents, such as news, novel) exist in current Internet. When a user browses a content-based webpage, a main object of concern is an article in the webpage. Generally speaking, a content-based webpage may include a large amount of information except for text, such as an advertisement. The foregoing large amount of information except for the text may bring about much interference in a user's reading.

To reduce interference to a user brought about by information except for text in a webpage, at present, some browsers (such as Chrome) may filter advertisement information in a webpage with a plug-in. Subsequently, interference in a user's reading generated by advertisement information may be reduced to some extent. However, only limited interference may be reduced, by using the foregoing method to filter advertisement information with a plug-in. A pure reading mode, which allows a user browsing a content-based webpage without interference of useless information, may be not provided,

### SUMMARY

In view of above, there is provided a method to improve reading experience of a browser, which may filter useless information except for text in a webpage.

An example of the present disclosure provides a method for displaying webpage contents in a browser, the method including:

obtaining a webpage requested to be read by a user;

determining whether the webpage is a content-based webpage;

when determining the webpage is the content-based webpage, extracting a title and text from the webpage based on a default rule, and outputting the title and text in the browser with a default reading mode.

An example of the present disclosure also provides a browser, which includes a memory, and a processor in communication with the memory, wherein the memory stores a webpage obtaining instruction, a text extracting instruction and an outputting instruction, which are executable by the processor,

the webpage obtaining instruction indicates to obtain a webpage requested to be read by a user;

the text extracting instruction indicates to determine whether the webpage is a content-based webpage, and extract a title and text from the webpage based on a default rule, when determining the webpage is the content-based webpage; and

the outputting instruction indicates to output the title and text, which are extracted from the webpage based on the text extracting instruction, in the browser with a default reading mode.

An example of the present disclosure also provides another browser, which includes: a webpage obtaining unit, a text extracting unit and an outputting unit, wherein

the webpage obtaining unit is configured to obtain a webpage requested to be read by a user;

the text extracting unit is configured to determine whether the webpage is a content-based webpage, and extract a title and text from the webpage based on a default rule, when the webpage is the content-based webpage, and

the outputting unit is configured to output the title and text, which are extracted from the webpage by the text extracting unit, in the browser with a default reading mode.

Based on the foregoing technical solution, it can be seen that, in an example of the present disclosure, after obtaining a webpage requested by a user, when determining the webpage is a content-based webpage, extract a title and text of the webpage, output the extracted title and text in a browser. Thus, useless information except for the text in a webpage may be filtered. The objective of enabling a user to browse a content-based webpage without interference of useless information may be achieved.

### BRIEF DESCRIPTIONS OF THE DRAWINGS

FIG. 1 is a flowchart illustrating a method for displaying webpage contents in a browser, in accordance with an example of the present disclosure.

FIG. 2 is a schematic diagram illustrating structure of a browser, in accordance with an example of the present disclosure.

FIG. 3 is a schematic diagram illustrating structure of another browser, in accordance with an example of the present disclosure.

### DETAILED DESCRIPTIONS

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

With reference to FIG. 1, FIG. 1 is a flowchart illustrating a method for displaying webpage contents in a browser, in accordance with an example of the present disclosure, which includes the following steps.

In step 101, obtain a webpage requested to be read by a user.

When needing to browse a webpage, a user needs to input a Uniform Resource Locator (URL) of the webpage in a URL address bar of a browser, or click on a hyperlink of the webpage, so as to trigger the browser to obtain the webpage.

In step 102, determine whether the webpage is a content-based webpage. When determining the webpage is the content-based webpage, extract a title and text from the webpage, according to a default rule, and output the title and text in the browser with a default reading mode.

Here, the content-based webpage refers to a webpage, in which an article is taken as a main body. The content-based webpage may include more text. A webpage providing contents, such as news, novel, information (e.g., blog) may belong to the content-based webpage, which generally has interference information, such as advertisement. In the example, interference information in a webpage may be removed, by extracting the title and text of the webpage.

In the example, title and text of a content-based webpage are extracted. It is necessary to determine whether a webpage is a content-based webpage. When determining a webpage is a content-based webpage, the title and text extracted from the webpage may be outputted from a browser.

In the example illustrated with FIG. 1, determine whether a webpage is a content-based webpage. When determining the webpage is the content-based webpage, there are various methods to extract the title and text from the webpage, according to a default rule, which will be respectively described in the following.

The first method is as follows. Establish a matching rule for content-based webpages with a same template in each website. Determine and extract the title and text, according to the matching rule.

In practical applications, webpages of the same type in each website may generally employ the same template. Regarding content-based webpages with the same template in a same website, locations of title and text of each webpage are the same. A content-based webpage may be parsed into a Document Object Model (DOM) tree. Subsequently, a DOM tree node located by a title of each webpage, and another DOM tree node located by text of each webpage are the same. Based on the foregoing characteristic, a matching rule may be established for all of the content-based webpages with the same template in each website. The matching rule may include a pair of key and value. The pair of key and value may include a key and a value. The key may include a URL matching rule of a content-based webpage using the template. The URL matching rule may be a URL regular expression about all of the content-based webpages using the template. For example, http:\/\/news.com\/\d{8,8}\/\d+.htm/i. The value may include title location information and text location information of a content-based webpage using the template. For example, {title: ‘#id: article h1’, content: ‘#id: article, class: content’} may represent that a DOM tree node located by the title is a child node of a node, the id attribute of which is article. The foregoing child node is a first level title (h1) node. A DOM tree node located by the text is a node, the id attribute of which is article, and the class attribute of which is content.

In this case, the processes of determining whether a webpage is a content-based webpage, when determining the webpage is the content-based webpage, extracting the title and text from the webpage according to a default rule, may include the follows. Match a key of each matching rule established in advance with the URL of the webpage. When the matching is successful, obtain the title and text of the webpage, according to the title location information and text location information in the matching rule (that is, extract text of a DOM tree node located by the title as the title of the webpage, and extract text of a DOM tree node located by the text as the text of the webpage).

In the foregoing method, that is, establish a matching rule for content-based webpages with the same template in each webpage, the matching rule may be set and updated by a person. And accuracy thereof may be relatively high.

The second method is as follows. Determine and extract the title and text, according to an intelligent algorithm strategy of visual effects rendered by a webpage.

In practical applications, text of a content-based webpage may generally occupy a main part of display area, e.g., a first screen of the display area. Based on such characteristic, a webpage may be parsed into a DOM tree. Location information about each node (width, height occupied by the text of the node, as well as font size) in the DOM tree may be obtained. A visual attribute value of a node may be calculated, according to the location information of the node. When the visual attribute value of the node is larger than a default text visual attribute value, the webpage may be determined as the content-based webpage. Text of a node, the visual attribute value of which is larger than the default text visual attribute value, may be taken as the text of the webpage. Here, the visual attribute value of a node may represent a location relationship between the location of the node in the webpage and location of a main display area in the webpage. A larger visual attribute value of a node may represent that the location of the node in the webpage is closer to a central location of the main display area of the webpage. A smaller visual attribute value of a node may represent that the location of the node in the webpage is farther away from the central location of the main display area of the webpage. In addition, title of a webpage is generally located in label h1 (<h1>title<h1>). Under the circumstances that a webpage is the content-based webpage, when a node with label h1 exists in a DOM tree, text of the node with label h1 may be extracted and taken as the title of the webpage.

When calculating the visual attribute value of each node, according to the location information of each node in a DOM tree, the following formula may be employed.

ViewValue=a÷(height×width)×fondsize. ViewValue may represent a visual attribute value of a node. Height may represent the height occupied by the text of the node. Width may represent the width occupied by the text of the node. Fondsize may represent font size of the text of the node. In the above formula, a is an adjustment coefficient. An initial value of a is a default initial value (such as 1). When the id attribute of the node is one of the following, article, entry, post, body, column, main and content, a first default adjustment coefficient (such as 0.4) may be added to the value of a. When the class attribute of the node is one of the following, article, entry, post, body, column, main and content, the first default adjustment coefficient may be added to the value of a. When the id attribute of the node is one of the following, comment, combobox, disqus (a third party annotation plug-in system, titled disqus), foot, header, menu, rss, shoutbox, sidebar and sponsor, a second default adjustment coefficient (such as 0.8) may be subtracted from the value of a. When the class attribute of the node is one of the following, comment, combobox, disqus, foot, header, menu, rss, shoutbox, sidebar and sponsor, subtract the second default adjustment coefficient from the value of a.

The foregoing formula will be described in the following with an example.

Suppose a webpage includes the following source codes, <div id=“article”, class=“post”>, after parsing the webpage into a DOM tree, this part of contents may be parsed into a node with label div. The id attribute of the node is article, and the class attribute of the node is post. Subsequently, a=1+0.4+0.4=1.8.

Suppose a webpage includes the following source codes: <div id=“comment”, class=“post”>text</div>, after parsing the webpage into a DOM tree, this part of contents may be parsed into a node with label div. The id attribute of the node is comment. The class attribute of the node is post. Subsequently, a=1+0.4−0.8=0.6.

The third method is as follows. Determine and extract the title and text, based on a determining criterion, which is about multiple punctuation included in the text.

In practical applications, text of a webpage may generally include much punctuation. Based on such characteristic, the webpage may be parsed into a DOM tree. Text of each node in the DOM tree may also be extracted. When text of a node includes a node, number of punctuation of which exceeds a default number, the webpage may be determined as the content-based webpage. Subsequently, the text of the node may be taken as the text of the webpage. In addition, under the circumstances that a webpage is the content-based webpage, when a node with label h1 exists in the DOM tree, text of the node with label h1 may be taken as the title of the webpage.

The fourth method is as follows. Determine and extract the title and text, based on semantics of a label in a webpage.

Each label in a webpage may possess certain semantics. For example, label h1 may represent a title of a webpage. Article may represent text of a webpage. When each label is correctly used by a webpage, the text and title of the webpage may be extracted, based on the semantics of each label. Specifically speaking, a webpage may be parsed into a DOM tree. When a label article exists in a DOM tree, the webpage may be determined as the content-based webpage. Subsequently, text of the node with label article may be extracted and taken as the text of the webpage. In addition, under the circumstances that a webpage is the content-based webpage, when a node with label h1 exists in the DOM tree, text of the node with label h1 may be extracted and taken as the title of the webpage.

The fifth method is as follows. Determine and extract the title and text, by taking the foregoing second, third, fourth methods into consideration.

Actually, determine and extract the title and text may be completed, by using each of the foregoing second, third and fourth methods. However, correctness of a result may not be guaranteed. Determine and extract the title and text may be completed more accurately, by taking these three methods into consideration and calculating a weighted average value.

The processes of determining whether a webpage is the content-based webpage, when determining the webpage is the content-based webpage, extracting the title and text from the webpage based on the default rule may include the follows. Parse the webpage into a DOM tree, and calculate text weight of each node in the DOM tree. When a text weight of a node is larger than a default text weight, determine that the webpage is the content-based webpage. Extract the text of the node as the text of the webpage. When a node with label h1 exists in the DOM tree, extract text of the node with label h1 as the title of the webpage.

The process of calculating the text weight of each node in the DOM tree may include the follows. Obtain location information of a node. Calculate the visual attribute value of the node, based on the location information of the node. When the calculated visual attribute value is larger than a default text visual attribute value, add a first default weight to the text weight of the node. When the label of the node is article, add a second default weight to the text weight of the node. Extract the text information of the node. When number of punctuation in the text of the node exceeds a default number, add a third default weight to the text weight of the node.

In the example illustrated with FIG. 1, a template page of reading mode may be preset. In the template page, font type, font size and font color of title and text may be set. Besides, row spacing of text and margins may be set. Subsequently, a frame may be used to load the template page with the preset reading mode. Fill the title and text in the template page with the preset reading mode. Thus, contents of a webpage may be displayed in a browser with the preset reading mode.

In view of above, in the examples of the present disclosure, after obtaining contents of a webpage requested to be read by a user, when determining the webpage is the content-based webpage, title and text of the webpage may be obtained by utilizing characteristics of the content-based webpage (such as labels located by the title and text, the first screen of the webpage display area located by the title and text, and so on). Display the title and text of the webpage in the browser, by utilizing the preset reading mode. Remove useless information from the webpage. Display main contents of the webpage for a user. Subsequently, when browsing a content-based webpage, a user may be not interfered with useless information.

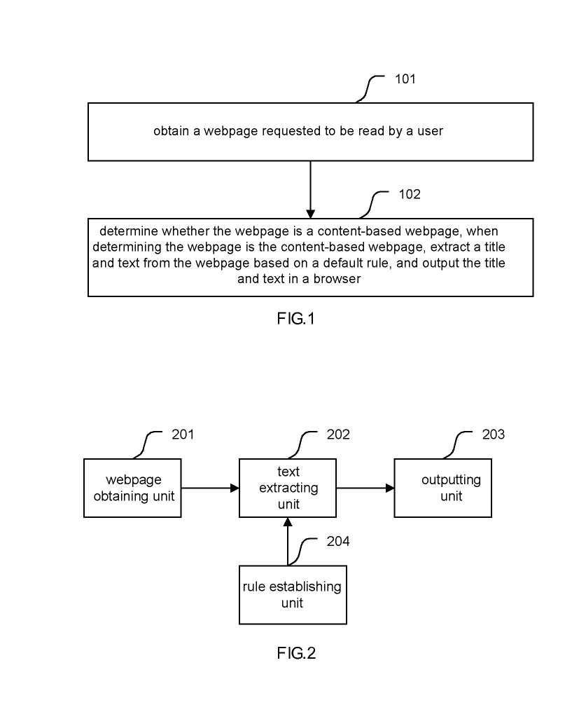

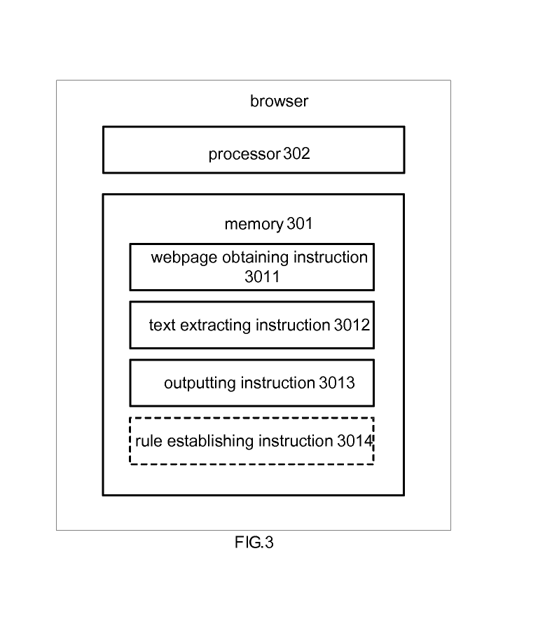

Detailed descriptions about a method for improving reading experience of a browser, which is put forward by an example of the present disclosure, are provided by the foregoing contents. An example of the present disclosure may also provide a browser, which will be described in the following with reference to FIG. 2.

FIG. 2 is a schematic diagram illustrating structure of a browser, in accordance with an example of the present disclosure. As shown in FIG. 2, the browser may include a webpage obtaining unit 201, a text extracting unit 202 and an outputting unit 203.

The webpage obtaining unit 201 is configured to obtain a webpage requested to be read by a user.

The text extracting unit 202 is configured to determine whether the webpage is a content-based webpage. When determining the webpage is the content-based webpage, the text extracting unit 202 is further configured to extract title and text from the webpage, based on a default rule.

The outputting unit 203 is configured to output the title and text, which are extracted by the text extracting unit 202 from the webpage, in the browser with a default reading mode.

The browser may further include a rule establishing unit 204.

The rule establishing unit 204 is configured to establish in advance a matching rule for all of the content-based webpages, which use a same template in each website. The matching rule may include a pair of key and value. The key may include a URL matching rule of a content-based webpage with the template. The value may include title location information and text location information of the content-based webpage, which uses the template.

The processes of the text extracting unit 202 determining whether the webpage is the content-based webpage, and extracting the title and text from the webpage based on the default rule, when determining the webpage is the content-based webpage, may include the follows. The text extracting unit 202 matches a key of each matching rule, which is established in advance, with the URL of the webpage. When the matching is successful, the text extracting unit 202 determines that the webpage is the content-based webpage, and obtains the title and text of the webpage, based on the title location information and text location information of the matching rule.

In the foregoing browser, the processes of the text extracting unit 202 determining whether the webpage is the content-based webpage, and extracting the title and text from the webpage based on the default rule, when determining the webpage is the content-based webpage, may include the follows. The text extracting unit 202 parses the webpage into a DOM tree, obtains location information about each node in the DOM tree, and calculates a visual attribute value of a node, based on the location information of the node. When the calculated visual attribute value of the node is larger than a default text visual attribute value, the text extracting unit 202 determines that the webpage is the content-based webpage, and extracts the text of the node, the visual attribute value of which is larger than the default text visual attribute value, as the text of the webpage. When a node with label h1 exists in the DOM tree, the text extracting unit 202 may extract the text of the node with label h1 as the title of the webpage.

In the foregoing browser, the processes of the text extracting unit 202 determining whether the webpage is the content-based webpage, and extracting the title and text from the webpage based on the default rule, when determining the webpage is the content-based webpage, may include the follows. The text extracting unit 202 parses the webpage into a DOM tree, and extracts text of each node in the DOM tree. When text of a node includes punctuation, the number of which is larger than a default number, the text extracting unit 202 may determine that the webpage is the content-based webpage, and take the text of the node as the text of the webpage. When a node with label h1 exists in the DOM tree, the text extracting unit 202 may extract the text of the node with label h1 as the title of the webpage.

In the foregoing browser, the processes of the text extracting unit 202 determining whether the webpage is the content-based webpage, and extracting the title and text from the webpage based on the default rule, when determining the webpage is the content-based webpage, may include the follows. The text extracting unit 202 parses the webpage into a DOM tree, and determines the webpage is the content-based webpage, when a node with label article exists in the DOM tree. The text extracting unit 202 further takes the text of the node with label article as the text of the webpage. When a node with label h1 exists in the DOM tree, the text extracting unit 202 may extract the text of the node with label h1 as the title of the webpage.

In the foregoing browser, the processes of the text extracting unit 202 determining whether the webpage is the content-based webpage, and extracting the title and text from the webpage based on the default rule, when determining the webpage is the content-based webpage, may include the follows. The text extracting unit 202 parses the webpage into a DOM tree, and calculates a text weight of each node in the DOM tree. When a text weight of a node is larger than a default text weight, the text extracting unit 202 determines that the webpage is the content-based webpage, and extracts the text of the node as the text of the webpage. When a node with label h1 exists in the DOM tree, the text extracting unit 202 may extract the text of the node with label h1 as the title of the webpage.

The process of calculating the text weight of each node in the DOM tree may include the follows. Obtain location information of a node, and calculate the visual attribute value of the node, based on the location information of the node. When the calculated visual attribute value of the node is larger than the default text visual attribute value, add a first default weight to the text weight of the node. When the label of the node is article, add a second default weight to the text weight of the node. Extract the text information of the node. When the text of the node includes punctuation, the number of which exceeds the default number, add a third default weight to the text weight of the node.

In the foregoing browser, the following formula may be employed, when the text extracting unit 202 calculates the visual attribute value of the node, based on the location information of the node.

ViewValue=a÷(height×width)×fondsize. ViewValue represents a visual attribute value of a node. Height represents height occupied by the text of the node. Width represents width occupied by the text of the node. Fondsize represents the font size of the text of the node. In the foregoing formula, “a” represents an adjustment coefficient, an initial value of which is a default initial value. When the id attribute of the node includes any one of article, entry, post, body, column, main and content, add a first default adjustment coefficient to the value of a. When the class attribute of the node includes any one of article, entry, post, body, column, main and content, add the first default adjustment coefficient to the value of a. When the id attribute of the node includes any one of comment, combobox, disqus, foot, header, menu, rss, shoutbox, sidebar and sponsor, subtract a second default adjustment coefficient from the value of a. When the class attribute of the node includes any one of comment, combobox, disqus, foot, header, menu, rss, shoutbox, sidebar and sponsor, subtract the second default adjustment coefficient from the value of a.

In the foregoing browser, the process of the outputting unit 203 outputting the title and text, which are extracted by the text extracting unit 202 from the webpage, in the browser with the default reading mode, may include the follows. The outputting unit 203 uses a frame to load a template page of the default reading mode, and fills the title and text in the template page of the default reading mode.

An example of the present disclosure also provides a machine readable storage medium, which may store instructions enabling a machine to execute the method for displaying webpage contents in a browser as mentioned above. Specifically speaking, a system or device with such storage medium may be provided. The storage medium may store software program codes, which may implement functions of any foregoing example. A computer (or Central Processing Unit (CPU), or Micro Processing Unit (MPU)) of the system or device may read and execute the program codes stored in the storage medium.

In this case, the program codes read from the storage medium may implement functions of any foregoing example. Thus, the program codes and storage medium may form a part of the present disclosure.

An example of the storage medium which provides the program codes may include software, hardware, magneto-optical disk, Compact Disk (CD) (such as CD-Read-Only Memory (ROM), CD-Recordable (CD-R), CD-ReWritable (RW), Digital Versatile Disc (DVD)-ROM, DVD-Random Access Memory (RAM), DVD-RW, DVD+RW), magnetic tape, non-volatile memory card and ROM. Alternatively, the program codes may be downloaded from a server computer via a communication network.

In addition, it can be seen that part of or all of the actual operations may be completed, by executing the program codes read by a computer, or by an Operating System (OS) of a computer based on instructions of the program codes, so as to implement functions of any foregoing example.

In addition, it should be understood that, the program codes read from the storage medium may be written into a memory, which is set within an expansion board of a computer, or an expansion board connected with the computer. Subsequently, part of or all of the actual operations may be executed by a CPU, which is installed on an expansion board or an expansion unit, based on instructions of the program codes, so as to implement functions of any foregoing example.

For example, FIG. 3 is a schematic diagram illustrating structure of another browser, in accordance with an example of the present disclosure. As shown in FIG. 3, the browser may include a memory 301, and a processor 302 in communication with the memory 301. The memory 301 may store a webpage obtaining instruction 3011, a text extracting instruction 3012 and an outputting instruction 3013, which are executable by the processor 302.

The webpage obtaining instruction 3011 indicates to obtain a webpage, which is requested to be read by a user.

The text extracting instruction 3012 indicates to determine whether a webpage is a content-based webpage. When determining that the webpage is the content-based webpage, the text extracting instruction 3012 indicates to extract the title and text from the webpage, according to a default rule.

The outputting instruction 3013 indicates to output the title and text, which are extracted from the webpage based on the text extracting instruction 3012, in the browser with a default reading mode.

The memory 301 further stores a rule establishing instruction 3014.

The rule establishing instruction 3014 indicates to establish in advance a matching rule for all of the content-based webpages, which use a same template in each website. The matching rule may include a pair of key and value. The key includes a URL matching rule of a content-based webpage with the template. The key includes the title location information and text location information of the content-based webpage, which uses the template.

During the processes of determining whether the webpage is the content-based webpage, and extracting the title and text from the webpage based on a default rule, when determining the webpage is the content-based webpage, the text extracting instruction 3012 may indicate to: match a key in each matching rule established in advance with the URL of the webpage. When the matching is successful, the text extracting instruction 3012 may indicate to determine that the webpage is the content-based webpage, and obtain the title and text of the webpage, based on the title location information and text location information in the matching rule.

In foregoing memory 301, during the processes of determining whether the webpage is the content-based webpage, and extracting the title and text from the webpage according to the default rule, when determining the webpage is the content-based webpage, the text extracting instruction 3012 may indicate to: parse the webpage into a DOM tree, obtain location information about each node in the DOM tree, and calculate a visual attribute value of a node, according to the location information of the node. When the calculated visual attribute value of the node exceeds the default text visual attribute value, the text extracting instruction 3012 may indicate to determine that the webpage is the content-based webpage, and extract the text of the node, the visual attribute value of which is larger than the default text visual attribute value, as the text of the webpage. When a node with label h1 exists in the DOM tree, the text extracting instruction 3012 may indicate to extract the text of the node with label h1 as the title of the webpage.

In foregoing memory 301, during the processes of determining whether the webpage is the content-based webpage, and extracting the title and text from the webpage based on the default rule, when determining the webpage is the content-based webpage, the text extracting instruction 3012 may indicate to: parse the webpage into a DOM tree, and extract text of each node in the DOM tree. When the text of a node includes punctuation, the number of which exceeds the default number, the text extracting instruction 3012 may indicate to determine that the webpage is the content-based webpage, and take the text of the node as the text of the webpage. When a node with label h1 exists in the DOM tree, the text extracting instruction 3012 may indicate to take the text of the node with label h1 as the title of the webpage.

In foregoing memory 301, during the processes of determining whether the webpage is the content-based webpage, and extracting the title and text from the webpage based on the default rule, when determining the webpage is the content-based webpage, the text extracting instruction 3012 may indicate to: parse the webpage into a DOM tree. When a node with label article exists in the DOM tree, the text extracting instruction 3012 may indicate to determine that the webpage is the content-based webpage, and extract the text of the node with label article as the text of the webpage. When a node with label h1 exists in the DOM tree, the text extracting instruction 3012 may indicate to extract the text of the node with label h1 as the title of the webpage.

In foregoing memory 301, during the processes of determining whether the webpage is the content-based webpage, and extracting the title and text from the webpage based on the default rule, when determining the webpage is the content-based webpage, the text extracting instruction 3012 may indicate to: parse the webpage into a DOM tree, and calculate a text weight of each node in the DOM tree. When a text weight of a node is larger than a default text weight, the text extracting instruction 3012 may indicate to determine that the webpage is the content-based webpage, and extract the text of the node as the text of the webpage. When a node with label h1 exists in the DOM tree, the text extracting instruction 3012 may indicate to take the text of the node with label h1 as the title of the webpage.

The process of calculating the text weight of each node in the DOM tree may include the follows. Obtain location information of a node, and calculate the visual attribute value of the node, based on the location information of the node. When the calculated visual attribute value of the node is larger than the default text visual attribute value, add a first default weight to the text weight of the node. When the label of the node is article, add a second default weight to the text weight of the node. Extract the text information of the node. When the text of the node includes punctuation, the number of which exceeds the default number, add a third default weight to the text weight of the node.

In the foregoing browser, the following formula may be used, when calculating the visual attribute value of the node indicated by the text extracting instruction 3012, based on the location information of the node.

ViewValue=a÷(height×width)×fondsize. ViewValue may represent a visual attribute value of a node. Height may represent the height occupied by the text of the node. Width may represent width occupied by the text of the node. Fondsize may represent the font size of the text of the node. In the foregoing formula, “a” is an adjustment coefficient. An initial value of a is a default initial value. When the id attribute of the node includes any one of the following, article, entry, post, body, column, main and content, add a first default adjustment coefficient to the value of a. When the class attribute of the node includes any one of the following, article, entry, post, body, column, main and content, add the first default adjustment coefficient to the value of a. When the id attribute of the node includes any one of the following, comment, combobox, disqus, foot, header, menu, rss, shoutbox, sidebar and sponsor, subtract a second default adjustment coefficient from the value of a. When the class attribute of the node includes any one of the following, comment, combobox, disqus, foot, header, menu, rss, shoutbox, sidebar and sponsor, subtract the second default adjustment coefficient from the value of a.

In the foregoing memory 301, during the process of outputting the title and text, which are extracted from the webpage based on the text extracting instruction 3012, in the browser with a default reading mode, the outputting instruction 3013 may indicate to use an iframe to load a template page of the default reading mode, and fill the title and text in the template page of the default reading mode.

The foregoing is examples of the present disclosure, which are not used for limiting the present disclosure. Any modifications, equivalent substitutions and improvements made within the spirit and principle of the present disclosure, should be covered by the protection scope of the present disclosure.

1. A method for displaying webpage contents in a browser, comprising:
obtaining a webpage requested to be read by a user;
determining whether the webpage is a content-based webpage;
when determining the webpage is the content-based webpage, extracting a title and text from the webpage based on a default rule, and outputting the title and text in the browser with a default reading mode.

2. The method according to claim 1, further comprising:
establishing in advance a matching rule for all of the content-based webpages with a same template in each website, wherein the matching rule comprises a pair of key and value, the key comprises a Uniform Resource Locator (URL) matching rule for a content-based webpage with the template, the key comprises title location information and text location information of the content-based webpage with the template;
wherein determining whether the webpage is the content-based webpage, and when determining the webpage is the content-based webpage, extracting the title and text from the webpage based on the default rule, comprise:
matching the key in each matching rule established in advance with the URL of the webpage; when the matching is successful, determining the webpage is the content-based webpage, and obtaining the title and text of the webpage, based on the title location information and the text location information in the matching rule.

3. The method according to claim 1, wherein determining whether the webpage is the content-based webpage, when determining the webpage is the content-based webpage, extracting the title and text from the webpage based on the default rule, comprise:
parsing the webpage into a Document Object Model (DOM) tree, obtaining location information of each node in the DOM tree;
calculating a visual attribute value of a node based on the location information of the node;
when the calculated visual attribute value of the node exceeds a default text visual attribute value, determining the webpage is the content-based webpage, and extracting the text of the node, the visual attribute value of which is larger than the default text visual attribute value, as the text of the webpage;
when a node with label h1 exists in the DOM tree, extracting the text of the node with label h1 as the title of the webpage.

4. The method according to claim 1, wherein determining whether the webpage is the content-based webpage, when determining the webpage is the content-based webpage, extracting the title and text from the webpage based on the default rule, comprise:
parsing the webpage into a DOM tree, and extracting the text of each node in the DOM tree;
when the text of a node comprises punctuation, number of which exceeds a default number, determining the webpage is the content-based webpage, and taking the text of the node as the text of the webpage;
when a node with label h1 exists in the DOM tree, extracting the text of the node with label h1 as the title of the webpage.

5. The method according to claim 1, wherein determining whether the webpage is the content-based webpage, when determining the webpage is the content-based webpage, extracting the title and text from the webpage based on the default rule, comprise:
parsing the webpage into a DOM tree;
when a node with label article exists in the DOM tree, determining the webpage is the content-based webpage, and extracting the text of the node with label article as the text of the webpage;
when a node with label h1 exists in the DOM tree, extracting the text of the node with label h1 as the title of the webpage.

6. The method according to claim 1, wherein determining whether the webpage is the content-based webpage, when determining the webpage is the content-based webpage, extracting the title and text from the webpage based on the default rule, comprise:
parsing the webpage into a DOM tree, and calculating a text weight of each node in the DOM tree;
when a text weight of a node is larger than a default text weight, determining the webpage is the content-based webpage, and extracting the text of the node as the text of the webpage;
when a node with label h1 exists in the DOM tree, extracting the text of the node with label h1 as the title of the webpage;
wherein calculating the text weight of each node in the DOM tree comprises: obtaining location information of a node, calculating a visual attribute value of the node, based on the location information of the node; when the calculated visual attribute value of the node is larger than a default text visual attribute value, adding a first default weight to the text weight of the node; when the label of the node is article, adding a second default weight to the text weight of the node; extracting text information of the node, when the text of the node comprises punctuation, number of which exceeds a default number, adding a third default weight to the text weight of the node.

7. The method according to claim 1, wherein outputting the title and text in the browser with the default reading mode comprises:
using an iframe to load a template page of the default reading mode, and fill the title and text in the template page of the default reading mode.

8. A browser, which comprises a memory, and a processor in communication with the memory, wherein the memory stores a webpage obtaining instruction, a text extracting instruction and an outputting instruction, which are executable by the processor,
the webpage obtaining instruction indicates to obtain a webpage requested to be read by a user;
the text extracting instruction indicates to determine whether the webpage is a content-based webpage, and extract a title and text from the webpage based on a default rule, when determining the webpage is the content-based webpage; and
the outputting instruction indicates to output the title and text, which are extracted from the webpage based on the text extracting instruction, in the browser with a default reading mode.

9. The browser according to claim 8, wherein the memory further stores a rule establishing instruction, which indicates to establish in advance a matching rule for all of the content-based webpages with a same template in each website, wherein the matching rule comprises a pair of key and value, the key comprises a Uniform Resource Locator (URL) matching rule of a content-based webpage with the template, the key comprises title location information and text location information of the content-based webpage with the template;
wherein when indicating to determine whether the webpage is the content-based webpage, extract the title and text from the webpage based on the default rule, when determining the webpage is the content-based webpage, the text extracting instruction further indicates to:
match a key in each matching rule established in advance with the URL of the webpage, when the matching is successful, determine the webpage is the content-based webpage, obtain the title and text of the webpage, based on the title location information and the text location information in the matching rule.

10. The browser according to claim 8, wherein when indicating to determine whether the webpage is the content-based webpage, extract the title and text from the webpage based on the default rule, when determining the webpage is the content-based webpage, the text extracting instruction further indicates to:
parse the webpage into a Document Object Model (DOM) tree, obtain location information of each node in the DOM tree, calculate a visual attribute value of a node based on the location information of the node, when the visual attribute value of the node exceeds a default text visual attribute value, determine the webpage is the content-based webpage, extract the text of the node, the visual attribute value of which is larger than the default text visual attribute value, as the text of the webpage; when a node with label h1 exists in the DOM tree, extract the text of the node with label h1 as the title of the webpage.

11. The browser according to claim 8, wherein when indicating to determine whether the webpage is the content-based webpage, extract the title and text from the webpage based on the default rule, when determining the webpage is the content-based webpage, the text extracting instruction further indicates to:
parse the webpage into a DOM tree, extract the text of each node in the DOM tree, when the text of a node comprises punctuation, number of which exceeds a default number, determine the webpage is the content-based webpage, and take the text of the node as the text of the webpage;
when a node with label h1 exists in the DOM tree, extract the text of the node with label h1 as the title of the webpage.

12. The browser according to claim 8, wherein when indicating to determine whether the webpage is the content-based webpage, extract the title and text from the webpage based on the default rule, when determining the webpage is the content-based webpage, the text extracting instruction further indicates to:
parse the webpage into a DOM tree, when a node with label article exists in the DOM tree, determine the webpage is the content-based webpage, extract the text of the node with label article as the text of the webpage;
when a node with label h1 exists in the DOM tree, extract the text of the node with label h1 as the title of the webpage.

13. The browser according to claim 8, wherein when indicating to determine whether the webpage is the content-based webpage, extract the title and text from the webpage based on the default rule, when determining the webpage is the content-based webpage, the text extracting instruction further indicates to:
parse the webpage into a DOM tree, calculate a text weight of each node in the DOM tree;
when the text weight of a node is larger than a default text weight, determine the webpage is the content-based webpage, extract the text of the node as the text of the webpage;
when a node with label h1 exists in the DOM tree, extract the text of the node with label h1 as the title of the webpage;
wherein when indicating to calculate the text weight of each node in the DOM tree, the text extracting instruction further indicates to:
obtain location information of a node, and calculate a visual attribute value of the node based on the location information of the node; when the visual attribute value of the node is larger than a default text visual attribute value, add a first default weight to the text weight of the node;
when the label of the node is article, add a second default weight to the text weight of the node;
extract text information of the node, when the text of the node comprises punctuation, number of which exceeds a default number, add a third default weight to the text weight of the node.

14. The browser according to claim 8, wherein when indicating to output the title and text, which are extracted from the webpage based on the text extracting instruction, in the browser with the default reading mode, the outputting instruction further indicates to:
use an iframe to load a template page of the default reading mode, and fill the title and text in the template page of the default reading mode.

15. A browser, comprising a webpage obtaining unit, a text extracting unit and an outputting unit, wherein
the webpage obtaining unit is configured to obtain a webpage requested to be read by a user;
the text extracting unit is configured to determine whether the webpage is a content-based webpage, and extract a title and text from the webpage based on a default rule, when the webpage is the content-based webpage, and
the outputting unit is configured to output the title and text, which are extracted from the webpage by the text extracting unit, in the browser with a default reading mode.
